(19) United States
(12) Patent Application Publication
(10) Pub. No.: US 2008/0107580 A1
(43) Pub. Date: May 8, 2008

(54) Removal Of Metal Contaminants From Ultra-High Purity Gases

(76) Inventors: Daniel Alvarez, San Diego, CA (US); Troy B. Scoggins, San Diego, CA (US); Tran Doan Nguyen, San Diego, CA (US); Yasushi Ohyashiki, Chiba (JP)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/631,985

(22) PCT Filed: Jul. 19, 2005
(86) PCT No.: PCT/US05/25608

§ 371 Date: Apr. 3, 2007

Related U.S. Application Data
(60) Provisional application No. 60/589,695, filed on Jul. 20, 2004.

(51) Int. Cl. B01D 53/02; C01B 25/06; C01B 3/56; C01B 33/04; C01B 35/02; C01B 6/34

(52) U.S. Cl. 423/215.5

(57) ABSTRACT

The invention is a method and apparatus for removing metal compounds from ultra-high purity gases using a purifier material comprising a high surface area inorganic oxide, so that the metals do not deposit on a sensitive device and cause device failure.

### RELATED APPLICATIONS

This application claims the benefit of U.S. Provisional Application No. 60/589,695, filed Jul. 20, 2004, the entire teachings of which are incorporated herein by reference.

### BACKGROUND OF THE INVENTION

Metal impurities are particularly problematic in the manufacture of electronic devices, such as semiconductors, liquid crystal displays, and optoelectronic and photonic devices. The electrical properties, e.g., conductivity, resistance, dielectric constant, and photoluminescence, are crucial to the performance of these devices. Small concentrations of metallic impurities have a profound impact on these properties, because metals are generally more conducting than the device materials, whether at the Fermi level or as individual charge carriers. The effect of metal concentration on the electrical properties of many semiconductor materials has been extensively studied in the published literature.

In addition to electrical properties, metal impurities also affect the mechanical properties of materials used in these devices. Properties such as hardness, plasticity, and corrosion resistance are often affected by metal concentration. As semiconductor circuitry dimensions decrease, an important factor is controlling the shape of the structures built on the device. The shape of the structures is controlled by the fabrication processes, e.g., etching and oxidation. In semiconductor etching and oxidation a reactive gas, either an etchant or an oxidant, reacts with the film and removes or oxidizes atoms in the layer. Metals are known to catalyze the local corrosion of thin films in etching, oxidation, and other processes. This local corrosion results in the “pitting” of the film, an undesirable property that is known to those skilled in the art. A less common, but sometimes equally deleterious issue is local hardening, which creates bumps or islands on the surface that affect the construction of additional layers. The effect of rounding of the top and bottom of gate structures is another undesirable property well-known to those skilled in the art.

Certain metals are often purposely incorporated into thin film layers in semiconductor devices in order to create a material that satisfies a set of electronic and physical properties. When present in controlled concentrations, metallic and metalloid elements are necessary dopants in the gate structures of semiconductors. Certain compounds of metals and metalloids possess excellent properties as dielectric layers, e.g., tungsten or titanium nitride. In certain optoelectronic devices, metals and metal compounds are responsible for the optical properties of the device. For example, many of the phosphors used in liquid crystal or flat panel displays are transition metal compounds. However, if the metal concentration is not strictly controlled, metal contamination results in defective device performance.

The International Technology Roadmap for Semiconductors (ITRS) states that the total metal concentration in common etchant gases, e.g., HCl, Cl₂, and BCl₃, should not exceed 1000 parts-per-billion (ppb) by weight (ppbw), with 10 ppbw specified for certain process dependent highly detrimental metals. This specification is for the current technology node and is expected to decrease to 1 ppbw for individual metals for future technology nodes. Outside of the relatively impure process of etching, the ITRS specifies less than 0.15 parts-per-trillion (ppt) total metal contamination (pptM) as airborne molecular contamination (AMC) in the vapor phase. This tolerance limit will decrease to <0.07 pptM with advancing technology.

### SUMMARY OF THE INVENTION

The present invention is a method for the purification of ultra-high purity gases used in the production of contamination susceptible devices. Specifically, the invention provides a method for removing metal contamination from ultra-high purity process gases used in the fabrication of contamination susceptible devices. Exemplary contamination sensitive devices in this invention include but are not limited to fiber optics, optoelectronic devices, photonic devices, semiconductors and flat panel or liquid crystal displays (LCDs).

In the method of the present invention, a high surface area inorganic oxide is made to contact an ultra-high purity gas stream and effect the removal of metal-containing contaminants from the gas. The high surface area inorganic oxide is not restricted to a particular elemental composition but should satisfy certain other requirements in order to be an effective metal removal agent. The high surface area inorganic oxide contains oxygen atoms on its surface (“surface oxygen atoms”) that have a coordination number less than the maximum coordination number for oxygen atoms in the bulk material (“bulk oxygen atoms”). This coordination number is preferably less than about 4 and more preferably less than about 3. The surface oxygen atoms of the present invention may be present on the external surfaces and the internal surfaces of the pores of the purification material. Examples of high surface area inorganic oxides are metal oxides, such as but not limited to zirconia, titania, vanadia, chromia, manganese oxide, iron oxide, zinc oxide, nickel oxide, lanthana, ceria, samaria, alumina or silica. In one embodiment, the high surface area metal oxide comprises a high silica zeolite with a Si/Al ratio of greater than or equal to about 4.

In an embodiment, the ultra-high purity gas stream contains an inert gas, such as nitrogen (N₂), helium (He) or Argon (Ar). In another embodiment, the ultra-high purity gas stream contains a gas that is corrosive in the presence of water. Examples of corrosive gases include HF, HCl, HBr, BCl₃, SiCl₄, GeCl₄, or ozone (O₃). Preferably, the corrosive gas is O₃.

In another embodiment, the ultra-high purity gas stream contains a gas that is oxidizing, such as F₂, Cl₂, Br₂, oxygen (O₂), or ozone (O₃). In yet another embodiment, the gas stream contains a hydride gas, such as borane (BH₃), diborane (B₂H₆), ammonia (NH₃), phosphine (PH₃), arsine (AsH₃), silane (SiH₄), disilane (Si₂H₆) or germane (GeH₄). For purposes of the invention, hydrogen (H₂) is also considered to be a hydride gas.

In another embodiment of the invention, the ultra-high purity gas includes one or more metal contaminants at a concentration below about 1000 parts per million by volume before being contacted by a purification material. Alternatively, or in addition, the ultra-high purity gas includes one or more metal contaminants at a concentration above 1 part per million by volume, or 1 part per billion by volume, before being contacted by a purification medium.

In the method of the present invention, total metal contamination in the gas stream is reduced to less than 100 ppt, preferably less than 10 ppt, more preferably less than 1 ppt.

The invention provides a means for ensuring that the ultra-high purity gases used in the manufacturing of contamination sensitive devices, especially semiconductors, are free of metal contamination and within the limits specified within the relevant industry. In this manner technological progress is enabled, defective products are minimized, and product stability is increased.

### BRIEF DESCRIPTION OF THE DRAWINGS

FIG. 1 shows a general mechanism of volatile metal capture by low coordination number surface oxygen atoms on a high surface area inorganic oxide.

FIG. 2 is an oblique view, partially cut away, of a canister for containment of the purifier material for use in this invention.

FIG. 3 is a schematic diagram of the gas process used to test the extraction of FeCl₃ from a gas stream with a TiO₂/molecular sieve purification material.

### DETAILED DESCRIPTION OF THE INVENTION

The method of the present invention involves contacting an ultra-high purity gas contaminated by metal compounds with a purification material (also referred to herein as a purifier material), the purification material removing the metal compounds from the gas, and removing the gas from contact with the purification material substantially free from metal contamination. After contact with the purification materials, the total metal contamination is reduced to levels below those specified for the manufacturing process. Using the methods of the invention, total metal contamination in the gas stream is reduced to less than 100 ppt by volume, preferably less than 10 ppt by volume, more preferably less than 1 ppt by volume.

The gas made to contact the purification material may be any ultra-high purity gas used in the manufacture of sensitive devices. The term “ultra-high purity gas” is recognized in the industry to mean a gas that is 99.9999% (6N) or better purity. Generally, such gases are purified by the manufacturer to ultra-high purity levels and are often further purified at the manufacturing facility to remove specified impurities to levels in the parts-per-million (ppm) or parts-per-billion (ppb) range on a volume basis.

Thus, in some embodiments of the invention, a ultra-high purity gas includes one or more metal contaminants at a concentration below about 1000 parts per million by volume, before the gas is contacted with one or more of the metal oxide purification mediums described herein. Alternatively, or in addition, the ultra-high purity gas includes one or more metal contaminants at a concentration above about 1 part per million by volume, or above about 1 part per billion by volume, before the gas is contacted with the metal oxide purification medium.

The gases purified by the method of the invention encompass all of the gases used in the processing of contamination sensitive devices. The “Yield Management” chapter of the ITRS, 2003 ed., lists the common gases and purification challenges with respect to these gases in Tables 114a and 114b. In a preferred embodiment of the present invention the gases purified from metal contamination are those gases that fall under the broad classifications of etchant or oxidant. Within these classifications many gases fall under further process specific groups, e.g., gases used for cleaning, stripping, ashing, and repairing. Particularly preferred gases decontaminated by the invention are the halogen compounds and ozone.

The present invention is applicable to the purification of many of the gases used in the various processes involved in the manufacturing of semiconductors and other sensitive devices. It is well-known to those skilled in the art that the halogen gases are especially problematic with regard to metal contamination. This can readily be seen from the boiling points in Table 1, which contains a particularly large number of halide compounds. The halogen gases include the commonly used halide and hydrogen halide gases, as well as other gases that are considered specialty gases in semiconductor processing. For example, these gases include nitrogen trihalides, especially NF₃; sulfur tetra-, penta-, and hexahalides, especially SF₆; silicon tetrahalides, such as SiCl₄; and germanium halides.

Second to the halogen compounds, other highly oxidizing gases present a high risk of metal contamination. A notable example of a common process gas that is considered highly oxidizing, corrosive, and susceptible to metal contamination is ozone (O₃). Ozone is commonly used in oxidation, stripping, and cleaning processes in semiconductor manufacturing. Like the hydrogen halide gases, ozone becomes corrosive for gas delivery systems when wet. The corrosive and oxidizing nature of ozone gas causes volatile and non-volatile metal contaminants to be easily carried by the gas stream.

Certain gases are known to exhibit a carrier effect in which metallic compounds and other metal-containing impurities are stabilized in the gas stream. In some cases the causes of this entrainment in the fluid stream is relatively well-known and in others it is not understood. Therefore, the third important class of gases that benefit from purification by the method of the present invention are such gases that exhibit this carrier property. These gases include ammonia, phosphine, wet inert gases, and wet CDA (clean dry air).

For these reasons the removal of metal contaminants from corrosive and oxidizing gases is a preferred embodiment of the present invention. After purification of these gases by the method of the present invention, the metal contamination is reduced to less than 100 ppt by volume, preferably less than 10 ppt by volume, and more preferably less than 1 ppt by volume.

The purification materials for use in the invention are high surface area inorganic oxides with surface oxygen atoms whose coordination number is lower than that of oxygen atoms in the bulk of the materials. It has been found that a number of purification materials effect the metals removal of the method of the invention. The common thread among the purification materials encompassed by the present invention is the presence of low coordination number oxygen atoms on the surface of a high surface area metal oxide.

The high surface area purifier materials for the instant invention preferably have a surface area of greater than about 20 m²/g, and more preferably greater than about 100 m²/g, although even greater surface areas are permissible. The surface area of the material should take into consideration both the interior and exterior surfaces. The surface area of the purifier material of the present invention can be determined according to industry standards, typically using the Brunauer-Emmett-Teller method (BET method). Briefly, the BET method determines the amount of an adsorbate or an adsorptive gas (e.g., nitrogen, krypton) required to cover the external and the accessible internal pore surfaces of a solid with a complete monolayer of adsorbate. This monolayer capacity can be calculated from an adsorption isotherm by means of the BET equation and the surface area is then calculated from the monolayer capacity using the size of the adsorbate molecule.

The types of metal oxides used in purification materials of the present invention include, but are not limited to, silicon oxides, aluminum oxides, aluminosilicate oxides (sometimes called zeolites), titanium oxides, zirconium oxides, hafnium oxides, lanthanum oxides, cerium oxides, vanadium oxides, chromium oxides, manganese oxides, iron oxides, ruthenium oxides, nickel oxides, and copper oxides. In some instances these metal oxides are deposited on a high surface area substrate, such as a alumina or silica. In general, the binding properties of oxygen are enhanced by the presence of the electropositive nature of the metal. Thus, oxides utilizing more electropositive metals may generally act as better performing purification materials for attracting contaminants.

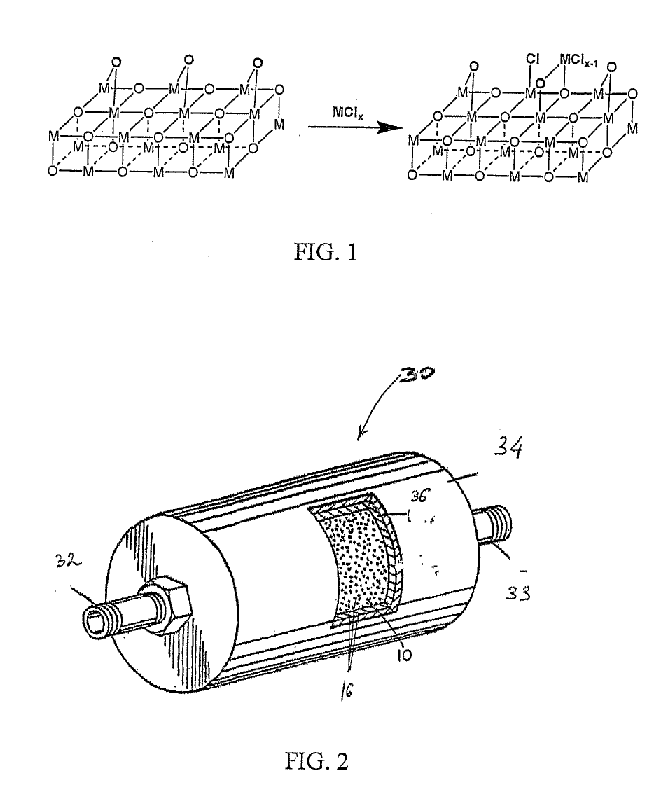

One aspect of a particular high surface area metal oxide is that the surface oxygen atoms have a coordination number lower than that of the oxygen atoms in the bulk material. The average coordination number of the surface oxygen atoms is less than or equal to about 4, preferably less than or equal to about 3. For example, the average coordination number of oxygen in zeolite aluminosilicate networks may be between 4 and 6, whereas surface hydroxyl groups that are common in zeolite structures have coordination numbers around 2. In manganese oxides, coordination numbers up to 8 are common, but surface oxides will often have coordination numbers less than or equal to 4. While we do not wish to restrict the present invention to any particular mechanism, a general mechanistic concept that accounts for the ability of low coordination number surface oxygen atoms to remove metal-containing impurities can be postulated. This general mechanistic concept is illustrated FIG. 1. The surface oxygen atoms shown in FIG. 1 have an average CN=2. In certain cases, the surface oxygen atoms may be bound to a hydrogen atom and have one less metal atom in their coordination sphere, in which case it is a surface hydroxyl group.

The metal compounds removed from the gases purified by the invention include, but are not limited to, those contained in Table 1. Table 1 lists the boiling points of a number of metal compounds that have enough vapor pressure to be present in the gas phase under the conditions often encountered in ultrahigh purity gas delivery systems.

TABLE 1
Boiling points of metallic compounds are not invariably high.

| | | | | | |
|---|---|---|---|---|---|
| TiCl₄ | 136° C. | [TaF₅]₄ | 229° C. | ReF₇ | 73.7° C. |
| TiBr₃ | 230° C. | TaCl₅ | 233° C. | FeCl₃•6H₂O | 280° C. |
| TiBr₄ | 234° C. | CrF₅ | 117° C. | [RuF₅]₄ | 227° C. |
| ZrBr₄ | 250° C. | CrO₃ | 250° C. | RuO₄ | 130° C. |
| VF₄ | sublimes | MoF₅ | 213° C. | OsF₆ | 46° C. |
| VF₅ | 48.3° C. | MoF₆ | 34° C. | OsO₄ | 130° C. |
| VCl₄ | 148° C. | MoCl₅ | 268° C. | IrF₆ | 53° C. |
| VI₃ | 80-100° C. | WF₆ | 17° C. | NiBr₂ | sublimes |
| [NbF₅]₄ | 234° C. | ReF₅ | 221° C. | PtF₆ | 69° C. |
| NbCl₅ | 247° C. | ReF₆ | 33.7° C. | Hg₂I₂ | 140° C. |
| AlCl₃ | 180° C. | GeCl₄ | 87° C. | PbCl₄ | 50° C. |
| [AlBr₃]₂ | 255° C. | GeBr₂ | 150° C. | SbF₅ | 141° C. |
| Ga₂Cl₆ | 201° C. | GeBr₄ | 186° C. | SbCl₃ | 223° C., |
| GaBr₃ | 279° C. | GeH₄ | −88° C. | SbBr₃ | 288° C. |
| Ga₂H₆ | 0° C. | Ge₂H₆ | 31° C. | SbH₃ | −17° C. |
| GeF₂ | 130° C. | SnCl₄ | 114° C. | BiF₅ | 230° C. |
| GeF₄ | −36.5° C. | SnBr₄ | 202° C. | BiH₃ | 17° C. |

The volatile metal compounds, such as metal halides, hydrides and oxides are especially problematic, because they are easily entrained in the gas stream. The volatile metal compounds can exist in the gas phase under the conditions-temperature and pressure-commonly found in manufacturing processes. Temperatures commonly fall in range of about 0° C. to about 300° C., with pressure in the range of about 0.1 mTorr to about 10 MTorr. In addition to the volatile molecular compounds of metals, other metal species are believed to contaminate process gases. While the mechanism by which these species become entrained is unknown, it is believed that coordination compounds and clusters may be stabilized in gas streams to form relatively homogenous mixtures, akin to the interactions that solubilize these compounds to form homogenous liquid mixtures. It is believed that these interactions were not important in prior art processes, because metal impurity tolerances were higher. However, when only 100 or 10 metal atoms per each 10¹² gas molecules are tolerated, relatively insignificant interactions may become important.

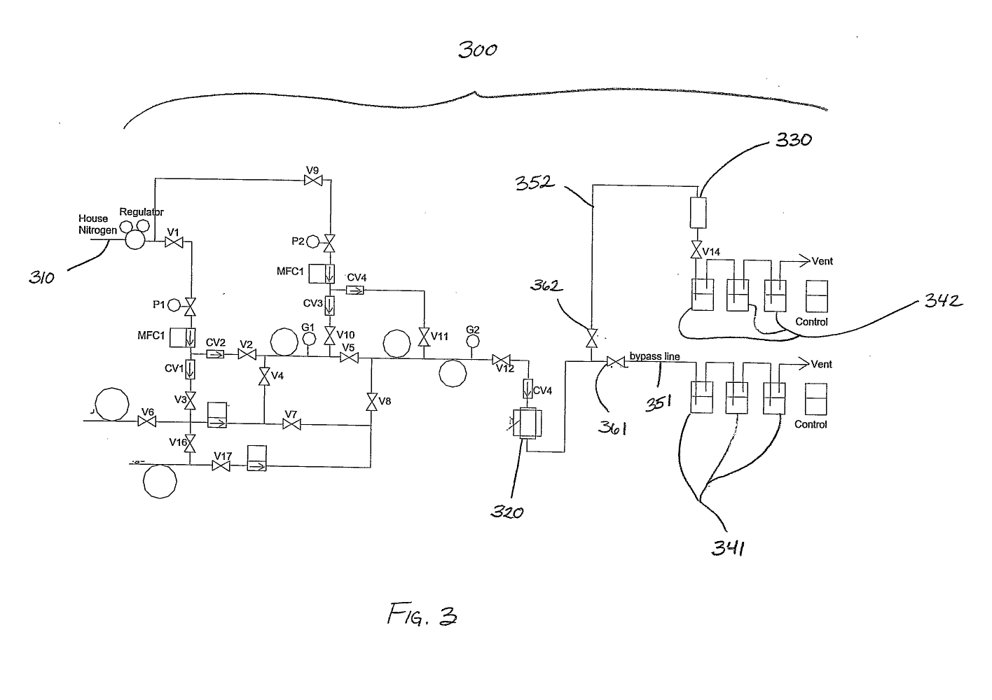

In the preferred embodiments of the invention, the purifier material is disposed within a canister in a form that is resistant to chemical and physical degradation by the gas. See FIG. 2 which illustrates a canister housing having an inlet and an outlet. For example, a high purity stainless steel canister, such as 316L stainless, with a minimal surface roughness, such as 0.2 ra, is one particularly preferred container. In certain embodiments wherein a corrosive, oxidizing, or otherwise reactive gas is used the container will be selected from materials which are stable under the operating conditions. The selection of the proper materials for the container is reasonable for one skilled in the art.

Referring to FIG. 2, in the present invention it is most convenient to have the purifier material contained within a corrosion-resistant housing or canister 30. For example, the use of a Teflon-based, or lined, canister is preferably utilized in some embodiments. Typically, canister 30 includes gas ports 32 and 33 for attaching to gas flow lines. Typically, for flow lines for various common gas streams, one will be dealing with gas flow rates in the range of about 1-300 standard liters of gas per minute (slm) and desired lifetimes in the range of 24 months. Operating temperatures of the gases may range from −80° C. to +100° C. and maximum inlet pressures to the canister 30 are commonly in the range of about 0 psig to 3000 psig (20,700 kPa). While any convenient container may be used, preferred are cylindrical canisters 30 with diameters in the range of about 3-12 in. (6-25 cm) and lengths of 4-24 in. (8-60 cm). The canister size will be dependent upon the gas flow rate and volume, the activity of the purifier material, and the amount of water to be removed, since it is necessary to have sufficient residence time in the device 30 to removal metal contaminants to levels less than 100 ppt.

In one embodiment, canister 30 has a wall 34 made of stainless steel or other metal which is resistant to corrosion. In another embodiment, the inside surface of wall 34 can be coated with a corrosion-resistant coating 36. In most cases these coatings will simply be inert materials which are resistant to corrosion by the specific material being dehydrated. However, it may be desirable to make the coating 36 on the inside of wall 34 of container 30 from Teflon®, Sulfinert, or similar polymeric materials.

### EXAMPLES

The following examples are meant to illustrate particular aspects of some embodiments of the invention. The examples are not intended to limit the scope of any particular embodiment of the invention that is utilized.

### Example 1

### Purification of 10 Metal Contaminants from a Copper Piping System

Separate pairs of silicon wafers were exposed to three different environments, and subsequently analyzed for the presence of 10 selected metal contaminants using vapor phase decomposition with inductively coupled plasma mass spectrometry (VPD-ICP-MS). Each pair of silicon wafers was impinged with nitrogen gas stream and stored in a high-purity shipping cassette, triple sealed with plastic bags and clean room tape before use.

The first pair of wafers were examined for metal contaminants using VPD-ICP-MS right after removal from the storage cassettes.

The second pair of wafers were placed in a Class 100 laminar flow hood. High-purity nitrogen gas was passed through hundreds of feet of a copper piping system. Subsequently, the gas was passed through a gas purifier in which the purification material is nickel/nickel-oxide embedded on a silicon dioxide support at a volumetric flow rate of less than 60 standard liters per minute (slm). Nitrogen leaving the purifier was carried by stainless steel piping and impinged on the wafer pair.

The third pair of silicon wafers was exposed to the high-purity nitrogen gas that was passed through the same copper piping system as the second pair except that the gas was not passed through the gas purifier.

VPD-ICP-MS was performed on all 3 pairs of silicon wafers by a third-party vendor (Chemtrace Corp., Fremont, Calif.). The silicon wafers were exposed to an acid, forming a liquid sample containing the metal impurities. The liquid sample was nebulized into an atmospheric argon plasma. Dissolved solids in the solutions were vaporized, dissociated and ionized and then extracted into a quadrupole mass spectrometric system to detect the presence of 10 selected metal contaminants. Levels of contaminants lower than 10¹⁰ atoms/cm² may be detected by the system.

Table 2 presents the VPD-ICP-MS results on the three pairs of wafers. The levels of particular metal contaminants are reported in part per billion (ppb) on a volume basis of the gas that was impinged on the wafer sample, the levels being back calculated from the VPD-ICP-MS results.

TABLE 2
Results of Metal Contamination on Silicon Wafers

| | | | Contamination | | Contamination | |
|---|---|---|---|---|---|---|
| | Contamination | | level on wafers | | level on wafers | |
| | level on cassette- | | exposed | | exposed to N₂ | |
| | wrapped wafers | | to N₂ with | | without purifier | |
| Metal | (ppb) | | purifier (ppb) | | (ppb) | |
| Contaminant | Wafer 1 | Wafer 2 | Wafer 1 | Wafer 2 | Wafer 1 | Wafer 2 |
| calcium | 0.5 | 0.5 | 0.5 | 0.5 | 3.1 | 1.2 |
| potassium | 0.5 | 0.5 | 0.5 | 0.5 | 11.0 | 1.1 |
| sodium | 0.5 | 0.5 | 0.5 | 2.2 | 11.0 | 0.9 |
| aluminum | 0.5 | 0.5 | 0.5 | 1.0 | 16.0 | 1.6 |
| iron | 0.1 | 0.1 | 0.1 | 0.6 | 6.5 | 4.2 |
| chromium | 0.05 | 0.05 | 0.05 | 0.05 | 1.0 | 0.8 |
| nickel | 0.1 | 0.1 | 0.1 | 0.1 | 0.8 | 0.5 |
| zinc | 0.2 | 0.2 | 0.2 | 0.2 | 2.0 | 0.2 |
| magnesium | 0.2 | 0.2 | 0.2 | 0.2 | 4.8 | 0.3 |
| copper | 0.1 | 0.1 | 0.1 | 0.1 | 0.3 | 0.1 |

The results of Table 2 show that wafers exposed to nitrogen gas transferred through the copper piping system, without the use of the purifier, contain substantially higher levels of metal contamination than the wafers that are immediately removed from the cassette wrapping. As well, exposing wafers to nitrogen gas transferred through the copper piping system, and subsequently contacted with the Ni/Ni-oxide purifier substrate, results in a contamination level for each contaminant that is generally substantially lower than the contamination levels of wafers where a purifier substrate is not utilized to clean the exposing nitrogen gas. Thus, the purifier material acts to remove the metal contaminants from the nitrogen gas stream.

### Example 2

### Removal of Iron (III) Chloride from a Nitrogen Gas Stream

An experiment was conducted to assess the ability of a purifier material to decontaminate FeCl₃ from a nitrogen gas stream. The experiment was performed using a test system 300 schematically diagrammed in FIG. 3.

Nitrogen gas was fed into the system 300 through line 310. About 40 mL of iron (III) chloride was filled into a housing 320, providing a source of FeCl₃ to entrain into the nitrogen test stream. A heating mantle was wrapped around the housing 320 to apply heat up to 200° C. to aid the entrainment of FeCl₃ into the nitrogen stream.

Two sets of three Teflon trap bottles 341, 342 were attached in parallel to the exit line of the housing 320. Each Teflon trap bottle was pre-cleaned and charged with a 2% dilute nitric acid solution for capturing metallic impurities. The bottles for each set were arranged in series. Valves 361, 362 controlled the flow of FeCl₃ entrained nitrogen gas into lines 351 and 352, respectively. Lines 351 and 352 directed FeCl₃ entrained nitrogen gas toward the sets of trap bottles 341, 342, in which gas is bubbled up through the bottom and metal impurities retained in the bottles.

One set of bottles (Bottle Set A) 341 was used to capture contaminants from the FeCl₃ entrained nitrogen gas, producing a value for the level of contamination in the nitrogen gas. The other set of bottles (Bottle Set B) 342 were placed downstream of a purifier 330, which was used to remove FeCl₃ contamination from the nitrogen gas. The purifier 330 utilized a combination of titanium dioxide and a silica aluminate zeolite as a purification material. Without being bound by theory, it is believed that the oxygen coordination of the TiO₂ provides the activity of the purification material to extract metal contaminants.

When the FeCl₃ entrained nitrogen gas was directed through line 351, and not allowed to pass through line 352, a flow rate of about 1.0 slm of nitrogen was applied at a pressure of 30 pounds per square inch gauge (psig) through Bottle Set A. When the FeCl₃ entrained nitrogen gas is directed through line 352, and not allowed to pass through line 351, a flow rate of about 0.54 slm of nitrogen was applied at a pressure of 60 psig through Bottle Set B. For each particular test run, i.e., collecting contaminants from one particular bottle set, gas flowed through the bottle set for a period of 24 hours. Upon completion of a test run, the particular set of capture bottles were sealed and the contents are analyzed. Inductively Coupled Plasma Mass Spectrometry (ICP-MS) was performed by a third-party vendor (Chemtrace Corp., Fremont, Calif.) to determine the amount of metal contamination present for 34 metal species. Depending upon the particular metal being detected, the lower detection limit of a metal species is in the range of about 5 to about 50 parts per trillion (ppt) on a basis of volume of gas collected. The exact limit depends upon the particular metal species being detected and the amount of gas analyzed.

Table 3 presents the ICP-MS results from capturing contaminants from Bottle Set A, the bottles in which a purifier is not utilized. Table 4 presents the ICP-MS results from capturing contaminants from Bottle Set B, the bottles in which a purifier is utilized. Each table presents the detection concentration limit of each particular metal species detected, and the detected concentration of each metal species in parts per billion on a volume basis of gas bubbled through the bottles.

TABLE 3
Concentration of Metal Contaminants Captured in Bottle Set A

| | | | Detection | |
|---|---|---|---|---|
| | ELEMENTS | | Limits (ppbv) | Concentration in ppbv |
| 1. | Aluminum | (Al) | 0.0008 | 0.0092 |
| 2. | Antimony | (Sb) | 0.0002 | 3.7 |
| 3. | Arsenic | (As) | 0.0004 | 0.79 |
| 4. | Barium | (Ba) | 0.00002 | 0.00007 |
| 5. | Beryllium | (Be) | 0.002 | <0.002 |
| 6. | Bismuth | (Bi) | 0.00005 | 0.00094 |
| 7. | Boron | (B) | 0.015 | 0.17 |
| 8. | Cadmium | (Cd) | 0.00015 | 0.032 |
| 9. | Calcium | (Ca) | 0.004 | 0.0051 |
| 10. | Chromium | (Cr) | 0.0004 | 0.10 |
| 11. | Cobalt | (Co) | 0.0002 | 0.00031 |
| 12. | Copper | (Cu) | 0.0004 | 0.040 |
| 13. | Gallium | (Ga) | 0.00005 | 8.0 |
| 14. | Germanium | (Ge) | 0.0002 | 0.068 |
| 15. | Gold | (Au) | 0.0002 | 0.010 |
| 16. | Iron | (Fe) | 0.003 | 170 |
| 17. | Lead | (Pb) | 0.0001 | 0.00057 |
| 18. | Lithium | (Li) | 0.002 | <0.002 |
| 19. | Magnesium | (Mg) | 0.0006 | 0.0025 |
| 20. | Manganese | (Mn) | 0.0002 | 0.0012 |
| 21. | Molybdenum | (Mo) | 0.0002 | 21 |
| 22. | Nickel | (Ni) | 0.0004 | 0.00063 |
| 23. | Niobium | (Nb) | 0.0001 | 0.014 |
| 24. | Potassium | (K) | 0.004 | <0.004 |
| 25. | Silver | (Ag) | 0.0001 | 0.0017 |
| 26. | Sodium | (Na) | 0.0015 | 0.0036 |
| 27. | Strontium | (Sr) | 0.00005 | 0.00019 |
| 28. | Tantalum | (Ta) | 0.0001 | <0.0001 |
| 29. | Thallium | (Tl) | 0.00005 | <0.00005 |
| 30. | Tin | (Sn) | 0.0002 | 0.21 |
| 31. | Titanium | (Ti) | 0.0002 | 0.17 |
| 32. | Vanadium | (V) | 0.0002 | 2.7 |
| 33. | Zinc | (Zn) | 0.0004 | 0.013 |
| 34. | Zirconium | (Zr) | 0.0004 | <0.0015 |
| | | | Total | 207 |

TABLE 4
Concentration of Metal Contaminants Captured in Bottle Set B

| | | | Detection | |
|---|---|---|---|---|
| | ELEMENTS | | Limits (ppbv) | Concentration in ppbv |
| 1. | Aluminum | (Al) | 0.002 | 0.0130 |
| 2. | Antimony | (Sb) | 0.0005 | <0.0005 |
| 3. | Arsenic | (As) | 0.001 | <0.001 |
| 4. | Barium | (Ba) | 0.00005 | <0.00005 |
| 5. | Beryllium | (Be) | 0.004 | <0.004 |
| 6. | Bismuth | (Bi) | 0.0001 | <0.0001 |
| 7. | Boron | (B) | 0.025 | 0.03 |
| 8. | Cadmium | (Cd) | 0.0003 | <0.0003 |
| 9. | Calcium | (Ca) | 0.006 | 0.014 |
| 10. | Chromium | (Cr) | 0.001 | <0.001 |
| 11. | Cobalt | (Co) | 0.0005 | <0.0005 |
| 12. | Copper | (Cu) | 0.001 | <0.001 |
| 13. | Gallium | (Ga) | 0.0001 | <0.0001 |
| 14. | Germanium | (Ge) | 0.0005 | 0.001 |
| 15. | Gold | (Au) | 0.0005 | <0.0005 |
| 16. | Iron | (Fe) | 0.005 | 0.010 |
| 17. | Lead | (Pb) | 0.0001 | 0.00042 |
| 18. | Lithium | (Li) | 0.004 | <0.004 |
| 19. | Magnesium | (Mg) | 0.001 | <0.001 |
| 20. | Manganese | (Mn) | 0.0005 | <0.0005 |
| 21. | Molybdenum | (Mo) | 0.0003 | <0.0003 |
| 22. | Nickel | (Ni) | 0.001 | <0.001 |
| 23. | Niobium | (Nb) | 0.0002 | <0.0002 |
| 24. | Potassium | (K) | 0.01 | <0.01 |
| 25. | Silver | (Ag) | 0.0001 | 0.00087 |
| 26. | Sodium | (Na) | 0.003 | <0.003 |
| 27. | Strontium | (Sr) | 0.0001 | <0.0001 |
| 28. | Tantalum | (Ta) | 0.0002 | <0.0002 |
| 29. | Thallium | (Tl) | 0.0001 | <0.0001 |
| 30. | Tin | (Sn) | 0.0003 | <0.0003 |
| 31. | Titanium | (Ti) | 0.0005 | <0.0005 |
| 32. | Vanadium | (V) | 0.0003 | <0.0003 |
| 33. | Zinc | (Zn) | 0.001 | <0.001 |
| 34. | Zirconium | (Zr) | 0.001 | <0.001 |
| | | | Total | 0.1018 |

As shown in Table 3, a substantial amount of iron, 170 ppb, was present in Bottle Set A, presumably from the FeCl₃ source. As well, a substantial amount of antimony, arsenic, gallium, molybdenum, tin, and vanadium contaminants were also spontaneously generated in the experiment. Table 4 shows that the amount of iron collected in the bottles downstream from the purifier was about 5 orders of magnitude lower than the amount collected without using the purifier. As well, the antimony, arsenic, gallium, molybdenum, tin, and vanadium contaminant concentrations were all reduced to values close to the detection limit of the individual metal species. Finally, a comparison of the total concentration of metal contaminants between Table 3 and Table 4 shows a decrease of 4 orders of magnitude when the purifier was utilized.

While this invention has been particularly shown and described with references to preferred embodiments thereof, it will be understood by those skilled in the art that various changes in form and details may be made therein without departing from the scope of the invention encompassed by the appended claims.

We claim:

1. A method for removing metal contaminants from a ultra-high purity gas stream by contacting the ultra-high purity gas stream with a purification material comprising a high surface area inorganic oxide containing surface oxygen atoms with a coordination number less than the bulk oxygen atoms.

2. The method of claim 1 wherein the ultra-high purity gas stream contains an inert gas.

3. The method of claim 2 wherein the inert gas includes at least one of nitrogen, helium, and argon.

4. The method of claim 1 wherein the ultra-high purity gas stream comprises at least one metal contaminant at a concentration below about 1000 parts per million by volume before contacting with the purification material.

5. The method of claim 1 wherein the ultra-high purity gas stream comprises at least one metal contaminant at a concentration above about 1 part per million by volume before contacting with the purification material.

6. The method of claim 1 wherein the ultra-high purity gas stream comprises at least one metal contaminant at a concentration above about 1 part per billion by volume before contacting with the purification material.

7. The method of claim 1 wherein the ultra-high purity gas stream comprises at least one metal contaminant at a concentration below about 100 parts per trillion by volume after contacting with the purification material.

8. The method of claim 1 wherein the ultra-high purity gas stream comprises at least one metal contaminant at a concentration below about 10 parts per trillion by volume after contacting with the purification material.

9. The method of claim 1 wherein the ultra-high purity gas stream comprises at least one metal contaminant at a concentration below about 1 part per trillion by volume after contacting with the purification material.

10. The method of claim 1 wherein the ultra-high purity gas stream contains a gas that is corrosive in the presence of water.

11. The method of claim 10 wherein the corrosive gas is HF, HCl, HBr, BCl₃, SiCl₄, GeCl₄, or ozone (O₃).

12. The method of claim 10 wherein the corrosive gas is O₃.

13. The method of claim 1 wherein the gas stream contains a gas that is oxidizing.

14. The method of claim 13 wherein the oxidizing gas is F₂, Cl₂, Br₂, oxygen (O₂), or ozone (O₃).

15. The method of claim 1 wherein the gas stream contains a hydride gas.

16. The method of claim 15 wherein the hydride gas is hydrogen (H₂), borane (BH₃), ammonia (NH₃), phosphine (PH₃), arsine (AsH₃), silane (SiH₄), or germane (GeH₄).

17. The method of claim 1 wherein the high surface area inorganic oxide contains surface oxygen atoms with a coordination number of less than or equal to about 4.

18. The method of claim 1 wherein the high surface area inorganic oxide comprises a high silica zeolite with a Si/Al ratio of greater than or equal to about 4.

19. The method of claim 1 wherein the high surface area inorganic oxide comprises zirconia, titania, vanadia, chromia, manganese oxide, iron oxide, zinc oxide, nickel oxide, copper oxide, lanthana, ceria, samaria, alumina, or silica.

20. The method of claim 1, wherein the purification material has a surface area greater than about 20 m²/g.
